(19) United States
(12) Patent Application Publication
(10) Pub. No.: US 2026/0352998 A1
(43) Pub. Date: Nov. 5, 2026

(54) INFORMATION PROCESSING DEVICE, INFORMATION PROCESSING METHOD, AND PROGRAM

(71) Applicant: SONY GROUP CORPORATION, TOKYO (JP)

(72) Inventor: RYUTARO WATANABE, TOKYO (JP)

(21) Appl. No.: 19/120,798

(22) PCT Filed: Oct. 3, 2023
(86) PCT No.: PCT/JP2023/036016

§ 371 Date: Apr. 14, 2025

(30) Foreign Application Priority Data
Oct. 20, 2022 (JP) 2022-168133

(51) Int. Cl. H04R 1/32; G05D 1/639

(52) U.S. Cl. CPC H04R 1/326; G05D 1/639

(57) ABSTRACT

The present disclosure relates to an information processing device, an information processing method, and a program that enable more effective sound collection. An information acquisition unit that acquires information necessary for calculating an optimal arrangement of a sound collection device that collects a sound of a collection target, the information including at least information indicating a position or orientation of the sound collection device. A calculation processing unit calculates an optimal arrangement of the sound collection device for collecting the sound of the collection target based on the information acquired by the information acquisition unit. An operation control unit controls an operation in the position or orientation of the sound collection device so as to achieve the arrangement calculated by the calculation processing unit. The present technology can be applied to, for example, a capturing and sound collection system.

### TECHNICAL FIELD

This disclosure relates to an information processing device, an information processing method, and a program, and in particular, to an information processing device, an information processing method, and a program that enable more effective sound collection.

### BACKGROUND ART

Conventionally, directional microphones are sometimes used to collect the sounds of actors in capturing videos such as movies and dramas. Generally, when installing a directional microphone at the end of a boom to collect sound, the audio staff (sound staff) holding the boom must be careful to ensure that neither themselves, the directional microphone, nor the boom appear in the shot. In addition, conventionally, the positioning of the directional microphone and the holding of the boom were performed by the audio staff (sound staff), but in the future, it is expected that so-called drones and robots will rearrange them.

For example, PTL 1 discloses an imaging system that determines the positions of a plurality of moving objects, including a moving object having an imaging unit that videos a subject and a moving object having an irradiation unit that irradiates the subject with light, in an imaging system that videos the subject using the moving objects.

PTL 2 discloses an information processing device that acquires status information of an imaging unit of a moving object, calculates the capturable area of the imaging unit based on the status information, and transmits information about the capturable area to the moving object.

### CITATION LIST

### Patent Literature

### [PTL 1]

WO 2019/189370

### [PTL 2]

WO 2021/024627

### SUMMARY

### Technical Problem

However, as described above, when the positioning or holding of a directional microphone is rearranged, it is required to be able to collect sound effectively.

The present disclosure has been made in consideration of such circumstances, and aims to enable more effective sound collection.

### Solution to Problem

An information processing device according to one aspect of the present disclosure includes an information acquisition unit that acquires information necessary for calculating an optimal arrangement of a sound collection device that collects a sound of a collection target, the information including at least information indicating a position or orientation of the sound collection device; a calculation processing unit that calculates an optimal arrangement of the sound collection device for collecting the sound of the collection target based on the information acquired by the information acquisition unit; and an operation control unit that controls an operation in the position or orientation of the sound collection device so as to achieve the arrangement calculated by the calculation processing unit.

An information processing method or program according to one aspect of the present disclosure includes acquiring information necessary for calculating an optimal arrangement of a sound collection device that collects a sound of a collection target, the information including at least information indicating a position or orientation of the sound collection device; calculating an optimal arrangement of the sound collection device for collecting the sound of the collection target based on the information; and controlling an operation in the position or orientation of the sound collection device so as to achieve the arrangement.

In one aspect of the present disclosure, information necessary for calculating an optimal arrangement of a sound collection device that collects a sound of a collection target, the information including at least information indicating a position or orientation of the sound collection device, is acquired. An optimal arrangement of the sound collection device for collecting the sound of the collection target is calculated based on the information. The operation in the position or orientation of the sound collection device is controlled so as to achieve the arrangement.

### BRIEF DESCRIPTION OF DRAWINGS

FIG. 1 is a diagram showing an example of the configuration of an embodiment of a capturing and sound collection system to which the present technology is applied.

FIG. 2 is a block diagram showing an example of the configuration of an information processing device.

FIG. 3 is a flowchart for explaining a first processing example of the capturing and sound collection processing.

FIG. 4 is a flowchart for explaining a second processing example of the capturing and sound collection processing.

FIG. 5 is a diagram for explaining considerations, conditions, and additional input information.

FIG. 6 is a diagram for explaining an example in which a noise source is considered.

FIG. 7 is a diagram for explaining an example in which a lighting device is considered.

FIG. 8 is a diagram for explaining a first example of collecting sounds from a plurality of collection targets.

FIG. 9 is a diagram for explaining a second example of collecting sounds from a plurality of collection targets.

FIG. 10 is a diagram for explaining a third example of collecting sounds from a plurality of collection targets.

FIG. 11 is a diagram for explaining a fourth example of collecting sounds from a plurality of collection targets.

FIG. 12 is a diagram for explaining an example of an arrangement screen.

FIG. 13 is a diagram for explaining an example of an arrangement screen.

FIG. 14 is a diagram for explaining a configuration example using a microphone cable.

FIG. 15 is a block diagram illustrating a configuration example of an embodiment of a computer to which the present technology is applied.

### DESCRIPTION OF EMBODIMENTS

Hereinafter, a specific embodiment to which the present technology is applied will be described in detail with reference to the drawings.

### Configuration Example of Capturing and Sound Collection System

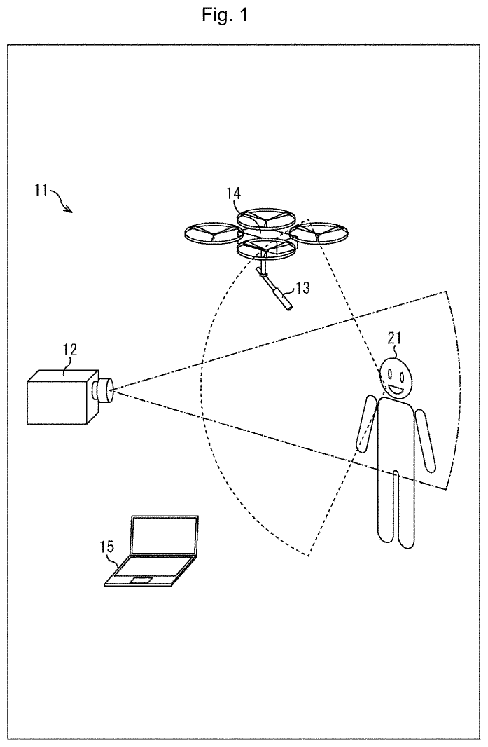

FIG. 1 is a diagram showing a configuration example of one embodiment of a capturing and sound collection system to which the present technology is applied.

As shown in FIG. 1, a capturing and sound collection system 11 is configured to include a capturing camera 12, a directional microphone 13, a moving device 14, and an information processing device 15.

For example, the capturing and sound collection system 11 is used at the movie or drama filming sets, and the directional microphone 13 can collect the sound of a specific actor captured by the capturing camera 12 as a collection target 21, such as the dialog spoken by the collection target 21. In the capturing and sound collection system 11, the information processing device 15 can control the operation of the moving device 14 on which the directional microphone 13 is mounted so that the directional microphone 13 is at the optimal position or orientation for collecting the sound of the collection target 21.

The capturing camera 12 is, for example, a capturing device that captures videos with an angle of view corresponding to the lens used.

The directional microphone 13 is, for example, a sound collection device with directional characteristics that mainly collects sounds in a narrow range along the sound axis and does not collect sounds outside that range.

The moving device 14 can be, for example, an unmanned aerial vehicle (a so-called drone) that can fly automatedly using a plurality of propellers, and moves the directional microphone 13 to a desired position or orientation according to the control of the information processing device 15.

The information processing device 15 calculates the optimal position or orientation of the directional microphone 13 for collecting the sound of the collection target 21 (hereinafter referred to as the optimal arrangement of the directional microphone 13), and controls the operation of the moving device 14 so that the sound of the collection target 21 can be collected with the optimal arrangement of the directional microphone 13.

For example, the information processing device 15 can estimate a capture range (the range surrounded by the dashed line in FIG. 1) that appears in the video captured by the capturing camera 12, based on the position, orientation, and angle of view of the capturing camera 12. The information processing device 15 can also estimate a recordable range (the range surrounded by the dashed line in FIG. 1) in which the direct sound of the collection target 21 can be recorded when the sound axis of the directional microphone 13 is directed toward the collection target 21, based on the position and orientation of the collection target 21.

Therefore, the information processing device 15 calculates the position of the directional microphone 13 that is inside the recordable range of the sound of the collection target 21, outside the capture range of the capturing camera 12, and where the directional microphone 13 and the moving device 14 can get closest to the collection target 21, as the optimal position of the directional microphone 13 for collecting the sound of the collection target 21. Furthermore, the information processing device 15 calculates the direction in which the sound axis of the directional microphone 13 is directed toward the collection target 21 at that position as the optimal orientation of the directional microphone 13 for collecting the sound of the collection target 21. The information processing device 15 then controls the operation of the moving device 14 so that the directional microphone 13 is arranged (positioned or oriented) optimally.

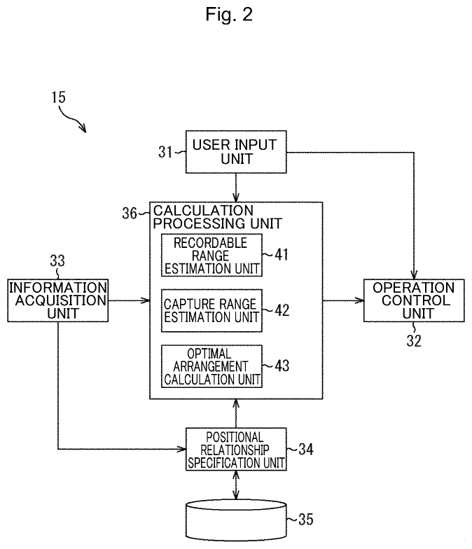

FIG. 2 is a block diagram illustrating a configuration example of the information processing device 15.

As shown in FIG. 2, the information processing device 15 is configured to include a user input unit 31, an operation control unit 32, an information acquisition unit 33, a positional relationship specification unit 34, a storage unit 35, and a calculation processing unit 36.

The user input unit 31 is used by the user of the capturing and sound collection system 11 to input various pieces of information to the information processing device 15. For example, the user inputs, using the user input unit 31, information indicating the angle of view of the capturing camera 12, information indicating the shape and directional characteristics of the directional microphone 13, and information indicating the shape of the moving device 14 as device information related to the device used in the capturing and sound collection system 11. The user input unit 31 supplies this device information to the calculation processing unit 36.

Furthermore, the user can use the user input unit 31 to specify the directional microphone 13 to be used for sound collection for each collection target 21, and the user input unit 31 supplies information indicating the directional microphone 13 specified for each collection target 21 to the calculation processing unit 36. Furthermore, the user can use the user input unit 31 to specify the position or orientation of the directional microphone 13 or adjust the position or orientation before the capturing camera 12 starts capturing, and the user input unit 31 supplies information indicating the position or orientation of the directional microphone 13 specified or adjusted by the user to the operation control unit 32.

Before the capturing camera 12 starts capturing, the operation control unit 32 controls the operation of the moving device 14 based on information indicating the position or orientation of the directional microphone 13 supplied from the user input unit 31, and moves the directional microphone 13 to a position or orientation according to the information. In addition, after the capturing camera 12 starts capturing, the operation control unit 32 controls the operation of the moving device 14 based on information indicating the optimal arrangement of the directional microphone 13 supplied from the calculation processing unit 36 as described below, and moves the directional microphone 13 to a position or orientation according to the information.

The information acquisition unit 33 acquires various pieces of information required for the calculation processing unit 36 to calculate the optimal arrangement of the directional microphone 13.

For example, the information acquisition unit 33 acquires information indicating the position and orientation of the capturing camera 12 before the capturing camera 12 starts capturing (hereinafter referred to as initial camera information), and supplies the information to the calculation processing unit 36. In addition, before the capturing camera 12 starts capturing, the information acquisition unit 33 acquires information indicating the position and orientation of the collection target 21 (hereinafter referred to as initial collection target information) and information indicating the position or orientation of the directional microphone 13 (hereinafter referred to as initial microphone information) for each collection target 21, and supplies the information to the positional relationship specification unit 34 and the calculation processing unit 36.

In addition, after the capturing camera 12 starts capturing, the information acquisition unit 33 continues to acquire information indicating the positions or orientations of the capturing camera 12, the collection target 21, and the directional microphone 13 at all times until the capturing ends. Then, the information acquisition unit 33 supplies the calculation processing unit 36 with information indicating the position and orientation of the capturing camera 12 at each time during capturing (hereinafter referred to as camera information), information indicating the position and orientation of the collection target 21 at each time during capturing (hereinafter referred to as collection target information), and information indicating the position or orientation of the directional microphone 13 at each time during capturing (hereinafter referred to as microphone information).

The positional relationship specification unit 34 specifies the positional relationship between the directional microphone 13 and the collection target 21 at the time when the capturing camera 12 starts capturing, based on the initial microphone information and the initial collection target information supplied from the information acquisition unit 33. For example, the positional relationship specification unit 34 specifies the direction in which the directional microphone 13 is directed and the distance from the directional microphone 13 to the collection target 21 as the positional relationship. Then, the positional relationship specification unit 34 stores the positional relationship information indicating the positional relationship between the directional microphone 13 and the collection target 21 in the storage unit 35.

The storage unit 35 stores the positional relationship information supplied from the positional relationship specification unit 34.

The calculation processing unit 36 receives information indicating the angle of view of the capturing camera 12, information indicating the shape and directional characteristics of the directional microphone 13, and information indicating the shape of the moving device 14 from the user input unit 31. Alternatively, the calculation processing unit 36 may acquire these pieces of information by communicating with other devices. Furthermore, the calculation processing unit 36 receives the camera information, collection target information, and microphone information from the information acquisition unit 33. Then, the calculation processing unit 36 calculates the optimal position or orientation of the directional microphone 13 for collecting the sound of the collection target 21 based on these pieces of information, and supplies information indicating the optimal arrangement of the directional microphone 13, which instructs the directional microphone 13 to be arranged at that position or orientation, to the operation control unit 32.

For example, the calculation processing unit 36 has a recordable range estimation unit 41, a capture range estimation unit 42, and an optimal arrangement calculation unit 43.

The recordable range estimation unit 41 estimates the recordable range of the sound of the collection target 21 at each time during capturing based on the collection target information supplied from the information acquisition unit 33.

The capture range estimation unit 42 estimates the capture range of the capturing camera 12 at each time during capturing based on the information indicating the angle of view of the capturing camera 12 supplied from the user input unit 31 and the camera information supplied from the information acquisition unit 33.

The optimal arrangement calculation unit 43 estimates an area inside the recordable range estimated by the recordable range estimation unit 41 and outside the capture range estimated by the capture range estimation unit 42 as a possible arrangement area in which the directional microphone 13 can be arranged. At this time, the optimal arrangement calculation unit 43 refers to the information indicating the shape of the directional microphone 13 and the information indicating the shape of the moving device 14, and estimates the possible arrangement area of the directional microphone 13 so that the directional microphone 13 and the moving device 14 do not enter the angle of view of the capturing camera 12.

Then, the optimal arrangement calculation unit 43 calculates the position that is closest to the collection target 21 within the possible arrangement area of the directional microphone 13 as the optimal position for collecting the sound of the collection target 21. Furthermore, based on the information indicating the directional characteristics of the directional microphone 13 supplied from the user input unit 31 and the collection target information supplied from the information acquisition unit 33, the optimal arrangement calculation unit 43 calculates the direction in which the sound axis of the directional microphone 13 is directed toward the collection target 21 at the optimal position for collecting the sound of the collection target 21 as the optimal direction for collecting the sound of the collection target 21. In this way, the optimal arrangement calculation unit 43 can calculate the optimal arrangement (position or orientation) of the directional microphone 13 and can supply information indicating the optimal arrangement of the directional microphone 13 to the operation control unit 32.

The capturing and sound collection system 11 configured in this way can collect the sound of the collection target 21 with the directional microphone 13 at an optimal arrangement. For example, the capturing and sound collection system 11 can collect the sound of the collection target 21 with the directional microphone 13 at a position that is inside the recordable range and outside the capture range and closest to the collection target 21, with the sound axis directed toward the collection target 21. This allows the capturing and sound collection system 11 to more effectively collect the sound of the collection target 21.

In addition, in the capturing and sound collection system 11, the user can specify the position or orientation of the directional microphone 13 before the capturing camera 12 starts capturing, and adjust the position or orientation of the directional microphone 13 as necessary while checking the sound to be collected. For example, the user can adjust the sound axis of the directional microphone 13 to face the mouth, forehead, chest, and the like of the collection target 21, or adjust the position of the directional microphone 13 so that the directional microphone 13 is at a distance that the sound can be easily heard.

In addition, in the capturing and sound collection system 11, by specifying and storing the positional relationship between the directional microphone 13 and the collection target 21 at the time when the capturing camera 12 starts capturing, it becomes possible to collect sound while maintaining this positional relationship, for example, within a range where the directional microphone 13 is not captured in the capturing camera 12 when the collection target 21 moves. That is, the operation control unit 32 can control the operation of the moving device 14 to read out the positional relationship information stored in the storage unit 35 and reproduce the positional relationship. The capturing and sound collection system 11 can reproduce the positional relationship between the directional microphone 13 and the collection target 21 when the same scene is captured a plurality of times, including rehearsals, at the movie or drama filming sets, or when capturing is interrupted and then resumed.

The capturing and sound collection system 11 can use the following first to third specification methods as a method for the information acquisition unit 33 to specify the position and orientation of the collection target 21.

In the first specification method, if a sensor is installed for the collection target 21 (such as an actor) specified in advance, the position and orientation of the collection target 21 can be specified by the sensor. Or, if a camera is installed on the moving device 14 as well as the directional microphone 13, the position and orientation of the collection target 21 can be specified by analyzing the video captured by the camera. Of course, the specification of the collection target 21 by the sensor and the specification of the collection target 21 by analyzing the video captured by the camera may be combined.

In the second specification method, the person at the center of the video captured by the capturing camera 12 can be specified as the collection target 21. For example, when a small number of people (for example, a person who speaks at a certain time) are the collection targets 21 among many people, it is necessary to direct the directional microphone 13 at the speaker every time the speaker speaks. Therefore, the video captured by the capturing camera 12 can be analyzed to specify the speaker as the collection target 21.

In the third specification method, for example, the speaker and his/her position can be specified based on the speech collected by a plurality of microphones or an array of microphones, and the speaker who made the speech can be specified as the collection target 21.

In addition, in the capturing and sound collection system 11, the sound collection position of the directional microphone 13 can be determined using information indicating the acoustic radiation characteristics of the collection target 21. For example, if the collection target 21 has acoustic radiation characteristics, the user can input information on the direction from which sound should be collected in advance using the user input unit 31, and the position or orientation of the directional microphone 13 is determined according to the information. In particular, for the collection target 21 for which there is know-how on the sound collection position, such as a musical instrument, it is preferable to store in advance the best information on where and from what distance sound should be collected. Note that if the collection target 21 does not have acoustic radiation characteristics, that is, if sound can be considered to be radiated in all directions, the orientation of the collection target 21 does not need to be taken into consideration when calculating the position or orientation of the directional microphone 13.

In addition, the capturing and sound collection system 11 can automatically perform post-processing on the collected sound by referring to information when the sound of the collection target 21 is collected. For example, in the capturing and sound collection system 11, if it is desired to remove the propeller noise of the moving device 14 contained in the sound signal in the post-processing of the collected sound, information indicating the rotation speed of the propeller of the moving device 14 is stored. Then, in post-processing, the frequency of the propeller noise can be specified according to the information, and the propeller noise of the moving device 14 can be removed. In addition, in the capturing and sound collection system 11, for example, in post-processing of collected sound, the volume and frequency characteristics can be adjusted according to the positional relationship with the collection target 21, the directional characteristics of the directional microphone 13, and the radiation characteristics of the collection target 21.

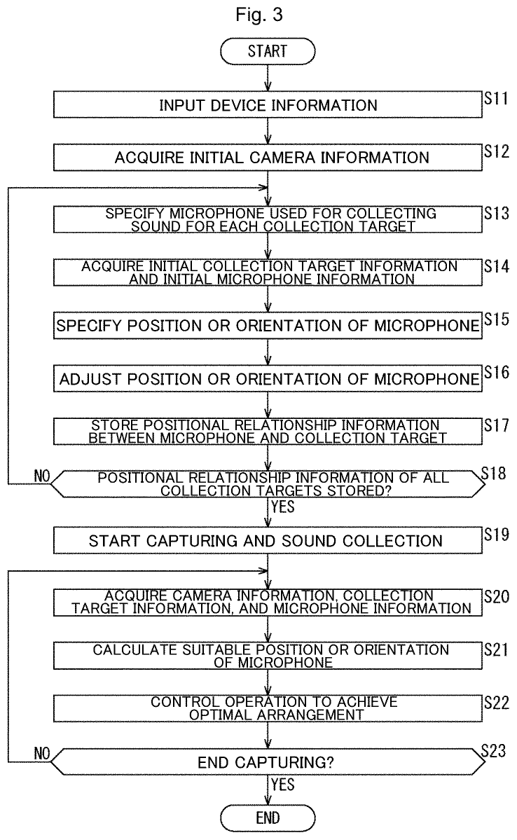

A first processing example of the capturing and sound collection process executed in the capturing and sound collection system 11 will be described with reference to the flowchart shown in FIG. 3.

In step S11, the user uses the user input unit 31 to input device information including information indicating the angle of view of the capturing camera 12, information indicating the shape and directional characteristics of the directional microphone 13, and information indicating the shape of the moving device 14. In response to this, the user input unit 31 supplies the device information input by the user to the calculation processing unit 36.

In step S12, the information acquisition unit 33 acquires initial camera information indicating the position and orientation of the capturing camera 12 before the capturing camera 12 starts capturing, and supplies the information to the calculation processing unit 36.

In step S13, the user uses the user input unit 31 to specify the directional microphone 13 to be used for collecting sound for each collection target 21. In response to this, the user input unit 31 supplies information indicating the directional microphone 13 specified for each collection target 21 to the calculation processing unit 36. In steps S14 to S17, pre-capturing processing is performed for each collection target 21 for which the directional microphone 13 was specified in step S13.

In step S14, the information acquisition unit 33 acquires initial collection target information indicating the position and orientation of the collection target 21 before the capturing camera 12 starts capturing. Furthermore, for the directional microphone 13 specified in step S13, the information acquisition unit 33 acquires initial microphone information indicating the position or orientation of the directional microphone 13 before the capturing camera 12 starts capturing.

In step S15, the user specifies the position or orientation of the directional microphone 13 using the user input unit 31. In response to this, the user input unit 31 supplies information indicating the position or orientation of the directional microphone 13 specified by the user to the operation control unit 32, and the operation control unit 32 controls the operation of the moving device 14 based on the information. As a result, the directional microphone 13 is arranged so as to be in the position or orientation specified by the user.

In step S16, the user adjusts the position or orientation of the directional microphone 13 using the user input unit 31 while checking the sound collected by the directional microphone 13 arranged in step S15. In response to this, the user input unit 31 supplies information indicating the position or orientation of the directional microphone 13 adjusted by the user to the operation control unit 32, and the operation control unit 32 controls the operation of the moving device 14 based on the information. As a result, the directional microphone 13 is arranged so as to be in the position or orientation adjusted by the user. In this way, the user adjusts the arrangement of the directional microphone 13 and checks the sound collected by the directional microphone 13, and the arrangement of the directional microphone 13 before the capturing camera 12 starts capturing is determined.

In step S17, the information acquisition unit 33 acquires initial microphone information in the arrangement determined in step S17 and supplies it to the positional relationship specification unit 34. Then, the positional relationship specification unit 34 determines the positional relationship between the directional microphone 13 and the collection target 21 at the time when the capturing camera 12 starts capturing based on the initial microphone information in the arrangement determined in step S17 and the initial collection target information provided in step S14, and stores the positional relationship information indicating the positional relationship in the storage unit 35.

In step S18, it is determined whether the positional relationships of all the collection targets 21 have been stored in the storage unit 35. If it is determined that the positional relationships of all the collection targets 21 have not been stored in the storage unit 35, the processing returns to step S13. In other words, in this case, in step S13, the directional microphone 13 to be used for collecting the sound of the next collection target 21 is specified, and the same processing is repeated thereafter.

On the other hand, if it is determined in step S18 that the positional relationships of all the collection targets 21 have been stored in the storage unit 35, the processing proceeds to step S19.

In step S19, the capturing camera 12 starts capturing, and the directional microphone 13 starts collecting sound.

In step S20, the information acquisition unit 33 acquires information indicating the positions or orientations of the capturing camera 12, the collection target 21, and the directional microphone 13, and supplies the camera information, the collection target information, and the microphone information to the calculation processing unit 36.

In step S21, the calculation processing unit 36 calculates the optimal position or orientation of the directional microphone 13 based on the camera information, the collection target information, and the microphone information supplied from the information acquisition unit 33 in step S20. The calculation processing unit 36 then supplies information indicating the optimal arrangement of the directional microphone 13, which instructs the directional microphone 13 to be arranged at that position or orientation, to the operation control unit 32.

In step S22, the operation control unit 32 controls the operation of the moving device 14 based on the information indicating the optimal arrangement of the directional microphone 13 supplied from the calculation processing unit 36 in step S21. As a result, the directional microphone 13 is arranged so as to be in the optimal position or orientation for collecting the sound of the collection target 21.

In step S23, it is determined whether or not to end the capturing by the capturing camera 12. If it is determined that the capturing by the capturing camera 12 is not to be ended, the processing returns to step S20, and the same processing is repeated thereafter. On the other hand, if it is determined in step S23 that the capturing by the capturing camera 12 is to be ended, the processing ends.

As described above, the capturing and sound collection system 11 performs the capturing and sound collection process to arrange the directional microphone 13 so as to be in the optimal position or orientation for collecting the sound of the collection target 21, thereby enabling more effective sound collection.

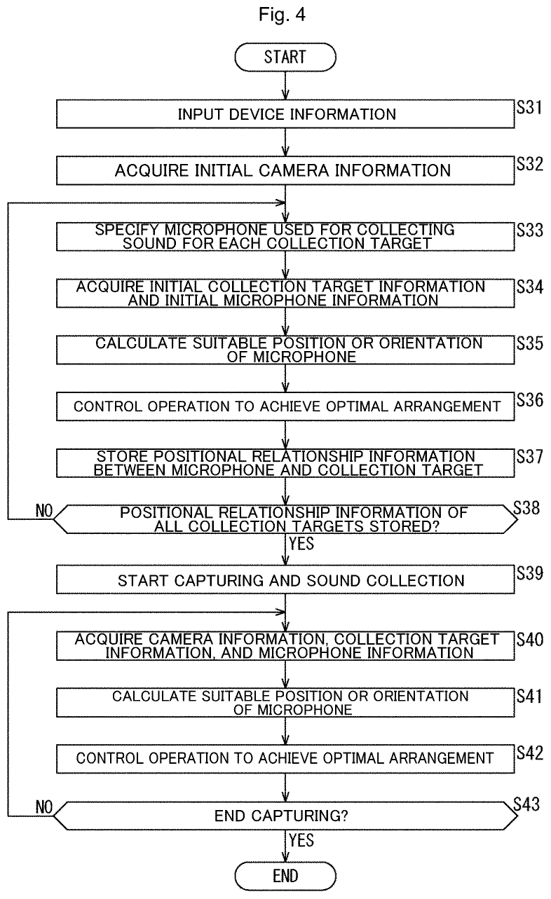

A second processing example of the imaging and sound recording process executed in the capturing and sound collection system 11 will be described with reference to the flowchart shown in FIG. 4.

In steps S31 to S34, the same processes as in steps S11 to S14 in FIG. 3 are performed, and in step S35, the calculation processing unit 36 calculates the optimal position or orientation of the directional microphone 13 based on the initial camera information, the initial collection target information, and the initial microphone information, and supplies information indicating the position or orientation to the operation control unit 32.

In step S35, the operation control unit 32 controls the operation of the moving device 14 based on the information indicating the position or orientation of the directional microphone 13 supplied from the calculation processing unit 36 in step S34. As a result, the directional microphone 13 is arranged so as to be in the optimal position or orientation calculated in step S34. After that, in steps S36 to S43, the same processes as in steps S16 to S23 in FIG. 3 are performed.

As described above, the capturing and sound collection system 11 performs the capturing and sound collection process to arrange the directional microphone 13 in the optimal position or orientation for collecting the sound of the collection target 21 from the start of capturing, thereby enabling more effective sound collection.

### Considerations

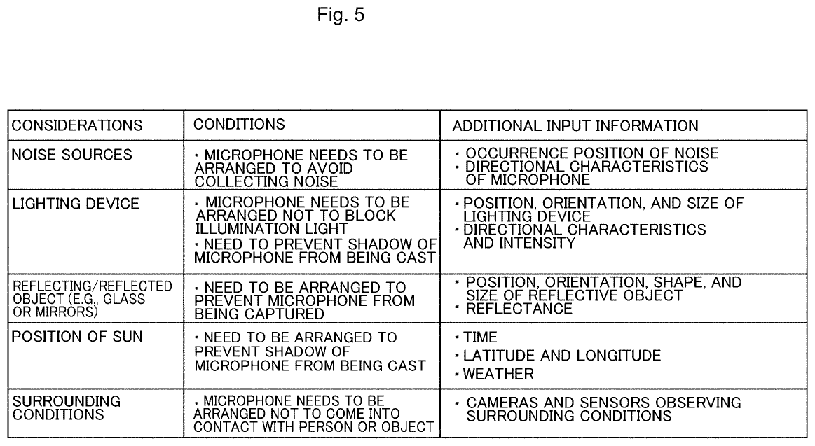

With reference to FIGS. 5 to 7, a method for determining the optimal position or orientation of the directional microphone 13 by considering various factors at the capturing site in addition to the positions or orientations of the capturing camera 12, the directional microphone 13, the collection target 21, and the like will be described.

As shown in FIG. 5, the capturing and sound collection system 11 needs to determine the optimal position or orientation of the directional microphone 13 by considering noise sources, lighting device, reflecting/reflected objects, the position of the sun, surrounding conditions, and the like, so as to eliminate their influence.

When considering noise sources, it is necessary to determine the position or orientation of the directional microphone 13 so as to avoid collecting noise other than that of the collection target 21. Therefore, in order to meet this condition, in the capturing and sound collection system 11, the position of the sound other than that of the collection target 21 and the directional characteristics of the directional microphone 13 are input to the information processing device 15 as additional input information.

When considering a lighting device, it is necessary to determine the position or orientation of the directional microphone 13 so that the directional microphone 13 does not block the illumination light and the shadow of the directional microphone 13 is not cast. Therefore, in order to meet this condition, the capturing and sound collection system 11 inputs the position, orientation, and size of the lighting device and the directional characteristics and intensity of the illumination light to the information processing device 15 as additional input information.

When considering reflecting/reflected objects such as glass and mirrors, it is necessary to determine the position or orientation of the directional microphone 13 so that the directional microphone 13 does not appear in the reflection of such objects. Therefore, in order to meet this condition, in the capturing and sound collection system 11, the position, orientation, shape, size, and reflectance of the reflecting/reflected object are input to the information processing device 15 as additional input information.

When considering the position of the sun, it is necessary to determine the position or orientation of the directional microphone 13 so that the shadow of the directional microphone 13 is not cast. Therefore, in order to meet this condition, in the capturing and sound collection system 11, the time, latitude, longitude, and weather are input to the information processing device 15 as additional input information.

When considering the surrounding conditions, it is necessary to determine the position or orientation of the directional microphone 13 so that the directional microphone 13 does not come into contact with people or objects around the directional microphone 13. Therefore, in order to meet this condition, the output of a camera or a sensor that observes the surrounding conditions is input to the information processing device 15 as additional input information.

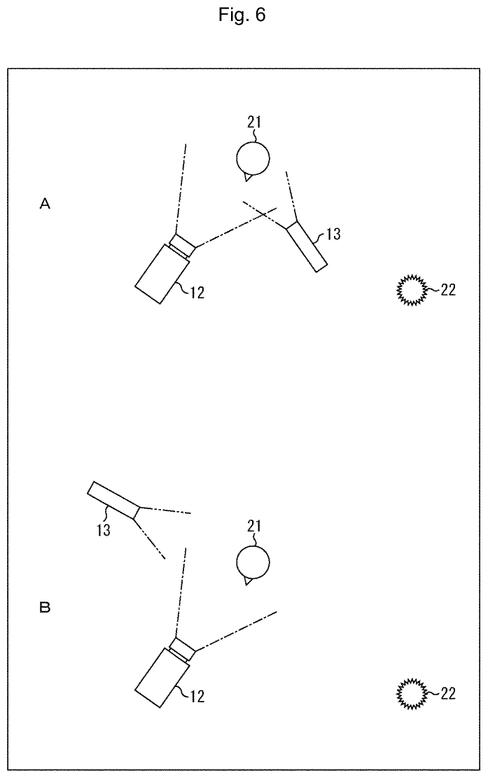

FIG. 6 is a diagram explaining an example of the optimal position or orientation of the directional microphone 13 when the noise source is taken into consideration.

As shown in FIG. 6, if there is a noise source 22 at the capturing site using the capturing and sound collection system 11, it is necessary to prevent the directional microphone 13 from collecting the noise of the noise source 22. For example, noise from the noise source 22 may be noise from various devices such as air conditioners, refrigerators, ventilation fans, or generators, traffic noise from aircraft or emergency vehicles, construction noise, and the like.

When calculating the optimal arrangement of the directional microphone 13 as described above, the optimal arrangement calculation unit 43 calculates the optimal arrangement of the directional microphone 13 based on the position of the noise source 22 and the directional characteristics of the directional microphone 13 so as to prevent the sound axis of the directional microphone 13 from being directed toward the noise source 22. In other words, the optimal arrangement calculation unit 43 calculates the optimal arrangement of the directional microphone 13 at a position that is closest to the collection target 21 within the possible arrangement area of the directional microphone 13, so that the sound axis of the directional microphone 13 is directed toward the collection target 21 and not the noise source 22.

Therefore, as shown in FIG. 6A, it is preferable to arrange the directional microphone 13 at a position outside the capture range so that the sound axis of the directional microphone 13 is directed toward the collection target 21, avoiding the noise source 22. Note that FIG. 6B shows an undesirable example in which the sound axis of the directional microphone 13 is directed toward the noise source 22, even though the directional microphone 13 is located outside the capture range and is directed toward the collection target 21.

Note that the capturing and sound collection system 11 may, for example, analyze the collected signal to output an alert when noise other than the sound of the collection target 21 is included.

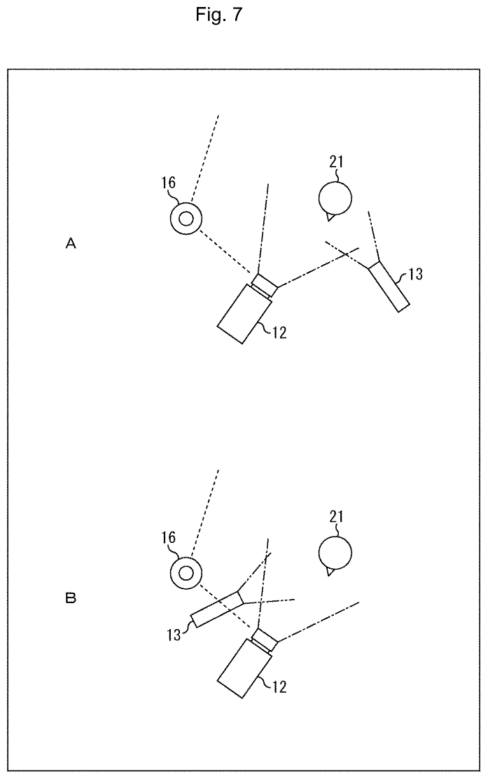

FIG. 7 is a diagram for explaining an example of the optimal position or orientation of the directional microphone 13 when considering a lighting device.

As shown in FIG. 7, when a lighting device 16 is present at a capturing site using the capturing and sound collection system 11, it is necessary to prevent the directional microphone 13 from blocking the illumination light and the shadow of the directional microphone 13 from being cast.

Then, when calculating the optimal arrangement of the directional microphone 13 as described above, the optimal arrangement calculation unit 43 calculates the optimal arrangement of the directional microphone 13 based on the position, orientation, and size of the lighting device 16 and the directional characteristics and intensity of the illumination light, so as to prevent the directional microphone 13 from blocking the illumination light and the shadow of the directional microphone 13 from being cast. In other words, the optimal arrangement calculation unit 43 calculates the optimal arrangement of the directional microphone 13 at a position that can be closest to the collection target 21 within the possible arrangement area of the directional microphone 13, so that the directional microphone 13 does not enter the area where the illumination light is irradiated by the lighting device 16.

Therefore, as shown in FIG. 7A, it is preferable to arrange the directional microphone 13 at a position outside the capture range and not within the area irradiated with the illumination light, so that the sound axis of the directional microphone 13 is directed toward the collection target 21. Note that FIG. 7B shows an undesirable example in which the directional microphone 13 is arranged at a position outside the capture range but within the area irradiated with the illumination light.

### Regarding Multiple Collection Targets

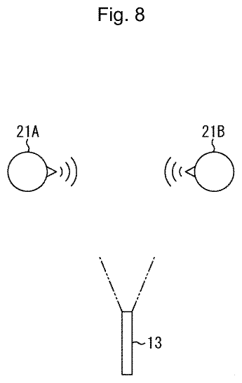

A method for collecting the sounds of a plurality of collection targets 21 will be described with reference to FIG. 8 to FIG. 11.

FIG. 8 shows an example of using one directional microphone 13 in a situation in which a plurality of collection targets 21 are engaged in a face-to-face conversation in close proximity.

As shown in FIG. 8, when the collection targets 21A and 21B are talking to each other at the same time, it is preferable to direct the sound axis of the directional microphone 13 to the midpoint between the collection targets 21A and 21B. Similarly, when two or more collection targets 21 are nearby and one directional microphone 13 is used, it is preferable to direct the sound axis of the directional microphone 13 to the midpoint between the plurality of collection targets 21. This allows the single directional microphone 13 to effectively collect the sounds of the plurality of collection targets 21.

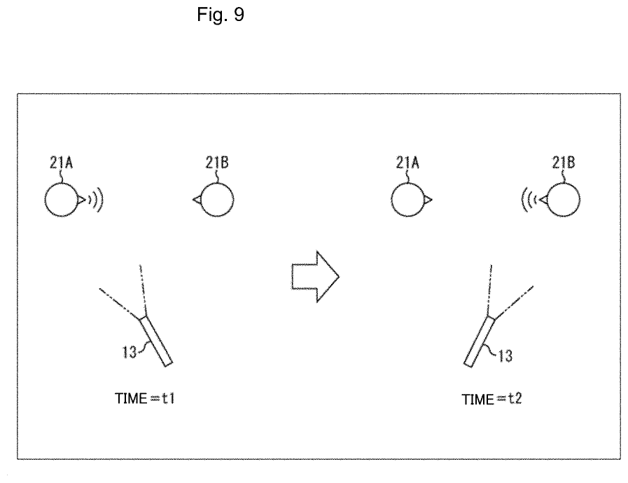

FIG. 9 shows an example of using one directional microphone 13 in a situation where a plurality of collection targets 21 are talking to each other nearby.

As shown in FIG. 9, when the collection targets 21A and 21B are nearby and talking alternately, it is preferable to change the direction of the sound axis of the directional microphone 13 according to the time when each of the collection targets 21A and 21B speaks. For example, according to a scenario prepared in advance, the sound axis of the directional microphone 13 can be directed toward the collection target 21A at time t1 when the collection target 21A speaks, and the sound axis of the directional microphone 13 can be directed toward the collection target 21B at time t2 when the collection target 21B speaks. This allows one directional microphone 13 to effectively collect the sounds of a plurality of collection targets 21.

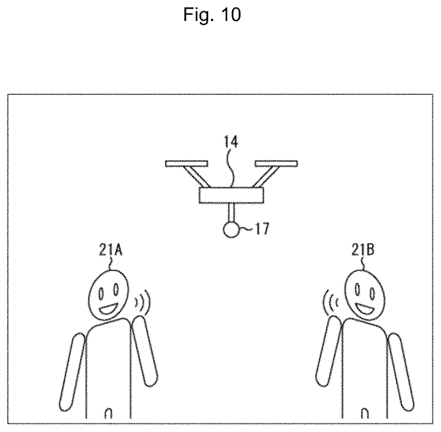

FIG. 10 shows an example of use in which one omnidirectional microphone 17 is used.

As shown in FIG. 10, when the omnidirectional microphone 17 is mounted on the moving device 14, it is preferable to arrange the omnidirectional microphone 17 at an equidistant location from the plurality of collection targets 21. This enables the single omnidirectional microphone 17 to more effectively collect the sounds of the plurality of collection targets 21.

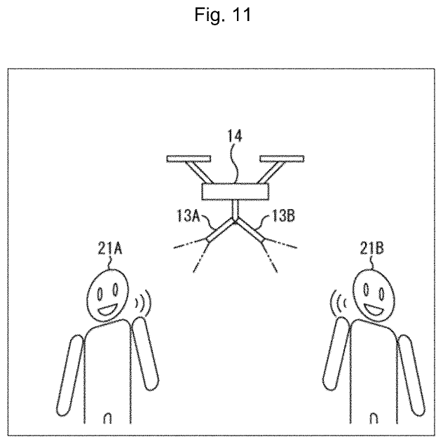

FIG. 11 shows an example of use in which a plurality of directional microphones 13 are used for each of the plurality of collection targets 21.

As shown in FIG. 11, two directional microphones 13A and 13B are mounted on the moving device 14, and the moving device 14 is arranged at a position midway between the collection targets 21A and 21B. It is preferable to direct the sound axis of the directional microphone 13A toward the collection target 21A and the sound axis of the directional microphone 13B toward the collection target 21B. This allows the plurality of directional microphones 13 to effectively collect the sounds of the plurality of collection targets 21.

### Arrangement Screen

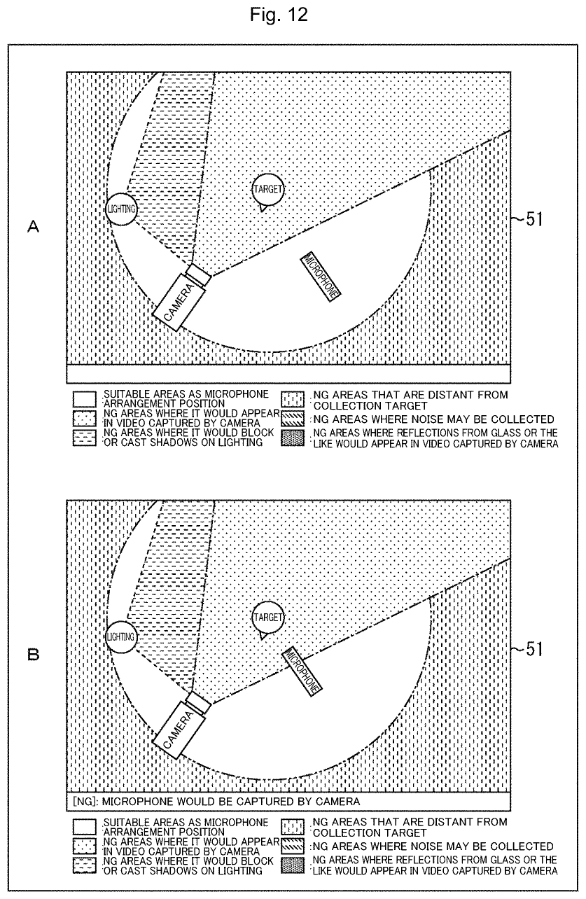

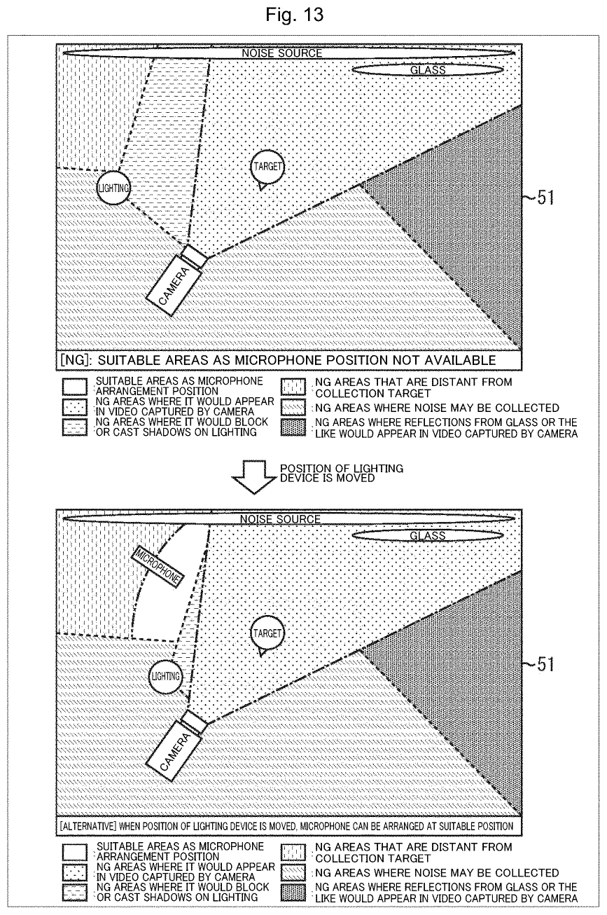

The arrangement screen displayed on the display unit of the information processing device 15 will be described with reference to FIGS. 12 and 13.

In the capturing and sound collection system 11, the situation of the capturing site is visualized as if looking down from the sky, and an arrangement screen 51 showing the arrangement of the capturing camera 12, directional microphone 13, lighting device 16, collection target 21, and the like can be displayed on the display unit of the information processing device 15. The situation of the capturing site can be visualized from the side or in a three-dimensional manner and displayed on the arrangement screen 51.

For example, the directional microphone 13 needs to be arranged within an area of a recordable range in which the direct sound of the collection target 21 can be recorded when the sound axis of the directional microphone 13 is directed toward the collection target 21. The directional microphone 13 also needs to be arranged outside the area of the capture range in which the directional microphone 13 appears in the video captured by the capturing camera 12. The directional microphone 13 also needs to be arranged so as not to block the illumination light and not to cast a shadow.

Therefore, as shown in FIG. 12, the arrangement screen 51 displays areas suitable for arranging the directional microphone 13, NG (No Good) areas where it would appear in the video captured by the capturing camera 12, NG areas where it would obstruct or cast shadows on the lighting device 16, NG areas that are distant from the collection target 21, and NG areas where reflections from glass or the like would appear in the video captured by the capturing camera 12. Furthermore, the arrangement screen 51 displays icons representing the capturing camera 12, the directional microphone 13, the lighting device 16, the collection target 21, and the like. The user can recognize whether the arrangement of the directional microphone 13 is appropriate or not by referring to the arrangement screen 51.

For example, the arrangement screen 51 shown in FIG. 12A shows an OK example in which the icon of the directional microphone 13 is displayed in an area appropriate for the arrangement of the directional microphone 13, indicating that the directional microphone 13 is optimally arranged.

On the other hand, the arrangement screen 51 shown in FIG. 12B shows an NG example in which the icon of the directional microphone 13 is displayed in an NG area because it would appear in the video captured by the capturing camera 12. An NG message is displayed indicating that the directional microphone 13 would appear in the video captured by the capturing camera 12. For example, in the capturing and sound collection system 11, when a user specifies the position of the directional microphone 13 or the moving device 14, if the position is not appropriate, a message notifying the user of the reason and an alert can be output.

In addition, in the capturing and sound collection system 11, if there is no appropriate area for the arrangement of the directional microphone 13, as in the arrangement screen 51 shown in the upper part of FIG. 13, an NG message is displayed indicating that there is no appropriate area for the arrangement of the directional microphone 13. In this case, the capturing and sound collection system 11 can present an alternative suggestion on which condition should be relaxed to obtain an appropriate area for the arrangement of the directional microphone 13.

That is, as in the arrangement screen 51 shown in the lower part of FIG. 13, an icon of the directional microphone 13 is displayed in an appropriate area for the arrangement of the directional microphone 13 obtained by moving the position of the lighting device 16.

Alternatively, a user interface may be displayed that allows the user to change the position or orientation of those objects on the arrangement screen 51 and check whether there is an appropriate area for the arrangement of the directional microphone 13.

In the capturing and sound collection system 11, when the moving device 14 is about to come into contact with another object or person, the operation control unit 32 controls the moving device 14 to preferentially move to a position or orientation that avoids contact with the other object or person, regardless of whether the moving device 14 will enter the capture range of the capturing camera 12. In this way, when avoiding contact with other objects or people is prioritized, the arrangement screen 51 notifies the user that the arrangement position of the directional microphone 13 is different from the expected one.

### Example of Configuration Using Microphone Cable

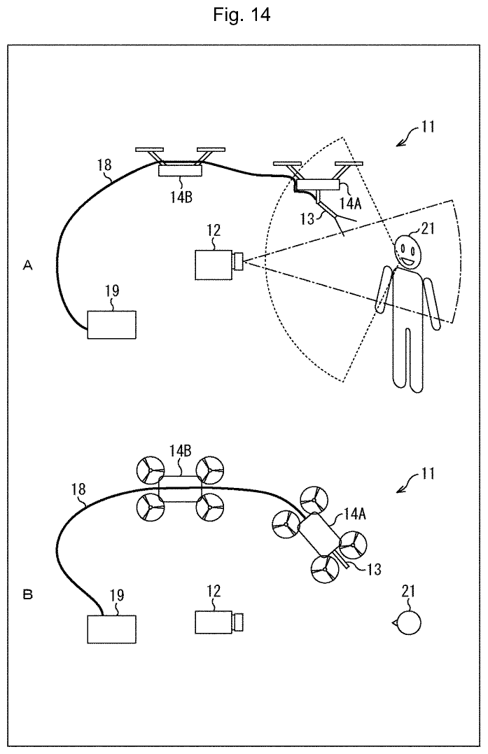

With reference to FIG. 14, an example of a configuration using a microphone cable will be described.

As shown in FIG. 14, the capturing and sound collection system 11 can be configured to use a microphone cable 18, and the directional microphone 13 is connected to a recording system 19 that records sound via the microphone cable 18. That is, the directional microphone 13 can transmit audio signals to the recording system 19 wirelessly, or can transmit audio signals to the recording system 19 through a wired connection via the microphone cable 18.

In the capturing and sound collection system 11 configured in this way, information indicating the length of the microphone cable 18 and information indicating the position of the recording system 19 are input to the information acquisition unit 33, and the calculation processing unit 36 controls the operation of the moving device 14A equipped with the directional microphone 13 so as to prevent the microphone cable 18 from appearing in the video captured by the capturing camera 12. In this case, in the capturing and sound collection system 11, the position of the moving device 14A is determined so that the distance from the moving device 14A to the recording system 19 is within a range equal to or less than the length of the microphone cable 18, for example.

Furthermore, the capturing and sound collection system 11 may use a moving device 14B for supporting the microphone cable 18 to prevent the microphone cable 18 from appearing in the video captured by the capturing camera 12.

Note that, although FIG. 14 illustrates one moving device 14B supporting the microphone cable 18, two or more moving devices 14B can be used to support the microphone cable 18. In the capturing and sound collection system 11, information indicating the number of a plurality of moving devices 14B supporting the microphone cable 18 is input to the information acquisition unit 33, and the calculation processing unit 36 controls the operation of the moving device 14A or one or more moving devices 14B so as to prevent the microphone cable 18 from appearing in the video captured by the capturing camera 12.

At this time, in the capturing and sound collection system 11, the positions of the plurality of moving devices 14B are determined, for example, so that the plurality of moving devices 14B support the microphone cable 18 at equal intervals between the moving device 14A and the recording system 19. In addition, the positions of the moving device 14A and the plurality of moving devices 14B are determined so that the distance from the moving device 14A to the recording system 19 via the plurality of moving devices 14B is within a range equal to or less than the length of the microphone cable 18.

When the omnidirectional microphone 17 is used in the capturing and sound collection system 11, the control of the orientation thereof is not necessary. When a spherical array microphone is used in the capturing and sound collection system 11, the sound of the collection target 21 arriving from any direction can be emphasized in post-processing, so the control of the orientation thereof is not necessary. Since the shape and diaphragm position of the microphone are different for each microphone, the capturing and sound collection system 11 must take these factors into consideration when calculating the optimal arrangement of the directional microphone 13.

In addition, in the capturing and sound collection system 11, in addition to the angle of view, the focal length and sensor size may be used as the device information related to the capturing camera 12. The video captured by the capturing camera 12 may be analyzed to detect whether the directional microphone 13 is captured.

In addition, in the capturing and sound collection system 11, in addition to the moving device 14, a crane, a rover, a wire, and the like may be used as the moving object that holds the directional microphone 13. At this time, in order to prevent cranes, rovers, wires, and the like from appearing in the video captured by the capturing camera 12, information regarding these components must be input to the information processing device 15 to calculate the optimal arrangement of the directional microphone 13.

Note that in this embodiment, when the directional microphone 13 is used, the position and orientation of the directional microphone 13 are controlled using information including both the position and orientation of the directional microphone 13. On the other hand, when the omnidirectional microphone 17 is used, the position of the omnidirectional microphone 17 is controlled using information including at least the position of the omnidirectional microphone 17.

### Computer Configuration Example

Next, the above-described series of processing (information processing method) can be also executed by hardware and can be also executed by software. In a case where the series of processing is executed by software, a program that configures the software is installed in a general-purpose computer or the like.

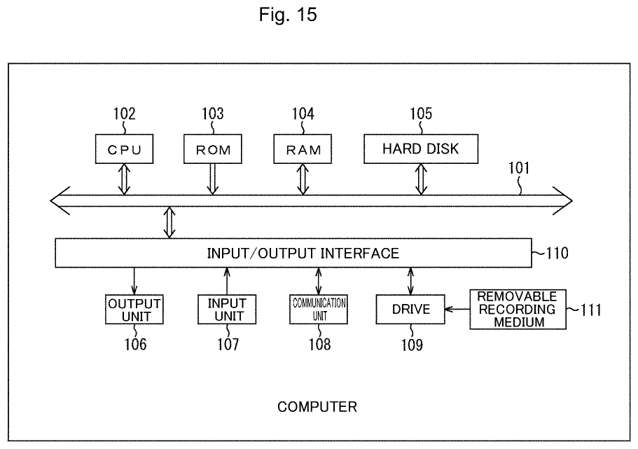

FIG. 15 is a block diagram illustrating a configuration example of an embodiment of a computer in which a program executing the above-described series of processing is installed.

The program can be recorded in advance in a hard disk 105 or a ROM 103 as a recording medium built into the computer.

Alternatively, the program can be stored (recorded) in a removable recording medium 111 driven by a drive 109. The removable recording medium 111 can be provided as so-called package software. Here, examples of the removable recording medium 111 include a flexible disc, a Compact Disc Read Only Memory (CD-ROM), a Magneto Optical (MO) disc, a Digital Versatile Disc (DVD), a magnetic disk, and a semiconductor memory.

Note that the program can be installed in the computer from the removable recording medium 111 as described above, or can be downloaded to the computer via a communication network or a broadcasting network and installed in the built-in hard disk 105. That is, for example, the program is transferred from the download site to the computer wirelessly via an artificial satellite for digital satellite broadcasting, or transferred to the computer by wire via a network such as a Local Area Network (LAN) or the Internet.

The computer includes a built-in Central Processing Unit (CPU) 102. An input/output interface 110 is connected to the CPU 102 via a bus 101.

When a user inputs an instruction by, for example, operating an input unit 107 through the input/output interface 110, the CPU 102 executes a program stored in the Read Only Memory (ROM) 103 in accordance with the instruction. Alternatively, the CPU 102 loads a program stored in the hard disk 105 into a Random Access Memory (RAM) 104 and executes the program.

As a result, the CPU 102 performs processing according to the above-described flowcharts or processing executed by components of the above-described block diagrams. Then, the CPU 102 causes an output unit 106 to output a processing result, causes a communication unit 108 to transmit the processing result, and causes the hard disk 105 to record the processing result, for example, via the input/output interface 110 as necessary.

The input unit 107 is composed of a keyboard, mouse, microphone, and the like. Furthermore, the output unit 106 is configured by a Liquid Crystal Display (LCD), a speaker, or the like.

The processing to be performed by the computer according to the program described herein may not necessarily be performed chronologically in the order described as the flowcharts. In other words, the processing to be performed by the computer according to the program also includes processing that is performed in parallel or individually (for example, parallel processing or processing by objects).

Furthermore, the program may be a program processed by one computer (processor) or may be distributed and processed by a plurality of computers. Furthermore, the program may be a program transmitted to a remote computer to be executed.

Moreover, in this description, a system means a set of a plurality of components (including devices and modules (parts)) regardless of whether or not all the components are contained in the same casing. Accordingly, a plurality of devices accommodated in separate casings and connected via a network and one device in which a plurality of modules are accommodated in one casing are all systems.

For example, a configuration described as one device (or processing unit) may be divided and configured as a plurality of devices (or processing units). On the other hand, the configuration described above as a plurality of devices (or processing units) may be collectively configured as one device (or processing unit). Of course, a configuration other than the above may be added to the configuration of each device (or each processing unit). Furthermore, a part of the configuration of a device (or processing unit) may be included in the configuration of another device (or another processing unit) as long as the configuration or operation of the system as a whole is substantially the same.

For example, the present technology may have a cloud computing configuration in which one function is shared with and processed by a plurality of devices via a network.

For example, the above-described program can be executed in any device. In this case, the device only needs to have necessary functions (functional blocks, and the like) and to be able to obtain necessary information.

Furthermore, for example, the respective steps described in the above-described flowchart may be executed by one device or in a shared manner by a plurality of devices. Furthermore, in a case where one step includes a plurality of steps of processing, the plurality of steps of processing included in this one step may be executed by one device or by a plurality of devices in a shared manner. In other words, it is also possible to execute the plurality of processing included in the one step as processing of a plurality of steps. On the other hand, it is also possible to execute processing described as a plurality of steps collectively as one step.

Note that, for a program executed by a computer, processing of steps describing the program may be executed chronologically in order described in this description or may be executed in parallel or individually at a necessary timing such as the time of invoking. In other words, the processing of the respective steps may be performed in an order different from the above-described order as long as there is no contradiction. Furthermore, the processing of the steps describing this program may be performed in parallel with processing of another program, or may be performed in combination with the processing of the other program.

The present technology described as various modes in the present description may be implemented independently alone as long as no contradiction arises. Of course, any plurality of present technologies may be implemented together. For example, some or all of the present technologies described in several embodiments may be implemented in combination with some or all of the present technologies described in the other embodiments. Furthermore, part or all of any above-described present technology can also be implemented together with another technology which has not been described above.

### Configuration Combination Example

The present technology can also be configured as follows.
(1)

An information processing device including:
an information acquisition unit that acquires information necessary for calculating an optimal arrangement of a sound collection device that collects a sound of a collection target, the information including at least information indicating a position or orientation of the sound collection device;
a calculation processing unit that calculates an optimal arrangement of the sound collection device for collecting the sound of the collection target based on the information acquired by the information acquisition unit; and
an operation control unit that controls an operation in the position or orientation of the sound collection device so as to achieve the arrangement calculated by the calculation processing unit.
(2)

The information processing device according to (1), wherein
the information acquisition unit acquires information indicating a position and orientation of a capturing device that captures the collection target, and information indicating the position and orientation of the collection target, and supplies the information to the calculation processing unit, and
the calculation processing unit calculates, as the optimal arrangement of the sound collection device, a direction toward the collection target at a position that can get closest to the collection target, which is inside a recordable range in which a direct sound of the collection target can be recorded when a sound axis of the sound collection device is directed toward the collection target, and outside a capture range in which the sound collection device appears in a video captured by the capturing device.
(3)

The information processing device according to (2), further including an input unit that inputs information used by the calculation processing unit, wherein the input unit inputs information indicating an angle of view of the capturing device, information indicating a shape and directional characteristics of the sound collection device, and information indicating a shape of a moving device that moves the sound collection device, to the calculation processing unit.
(4)

The information processing device according to (3), further including a positional relationship specification unit that specifies and stores a positional relationship between the sound collection device and the collection target before the capturing device starts capturing.
(5)

The information processing device according to (3), wherein
the operation control unit controls the operation in the position or orientation of the sound collection device according to specification or adjustment of the position or orientation of the sound collection device input to the input unit before the capturing device starts capturing.
(6)

The information processing device according to (3), wherein
the operation control unit controls the operation in the position or orientation of the sound collection device before the capturing device starts capturing so that the arrangement calculated by the calculation processing unit based on the information acquired before the capturing is achieved.
(7)

The information processing device according to (3), wherein
the calculation processing unit calculates the optimal arrangement of the sound collection device for collecting the sound of the collection target based also on information indicating a position of a noise source that emits noise other than the collection target.
(8)

The information processing device according to (3), wherein
the calculation processing unit calculates the optimal arrangement of the sound collection device for collecting the sound of the collection target based also on information about an irradiating device that irradiates the collection target with illumination light.
(9)

The information processing device according to any one of (1) to (8), wherein
when one sound collection device having directional characteristics is used for a plurality of collection targets, a sound axis of the sound collection device is directed to a midpoint of the plurality of collection targets.
(10)

The information processing device according to any one of (1) to (9), wherein
when one sound collection device having directional characteristics is used for a plurality of the collection targets, a sound axis of the sound collection device is directed toward each of the collection targets according to a time when each of the collection targets speaks.
(11)

The information processing device according to any one of (1) to (10), wherein
the sound collection device having omnidirectional characteristics is used for a plurality of the collection targets.
(12)

The information processing device according to any one of (1) to (11), wherein
a plurality of the sound collection devices having directional characteristics are used for each of the plurality of the collection targets.
(13)

The information processing device according to any one of (1) to (12), wherein
an arrangement screen is displayed on a display unit, which displays areas suitable for the arrangement of the sound collection device and areas inappropriate for the arrangement of the sound collection device, and which displays at least an icon of the sound collection device.
(14)

The information processing device according to (13), wherein
when the arrangement of the sound collection device is not suitable, a message is displayed on the arrangement screen, which notifies reasons therefor.
(15)

The information processing device according to (13) or (14), wherein
the arrangement screen presents an alternative for appropriately arranging the sound collection device if the arrangement of the sound collection device is not appropriate.
(16)

The information processing device according to any one of (1) to (15), wherein
when a moving device that moves the sound collection device is about to come into contact with another object or person, the operation control unit performs control to preferentially move the moving device so as to avoid contact with the other object or person.
(17)

The information processing device according to any one of (1) to (16), wherein
the sound collection device is connected to a recording system that records sound via a microphone cable, and
the calculation processing unit controls the operation of the moving device equipped with the sound collection device or one or more moving devices supporting the microphone cable so as to prevent the microphone cable from appearing in the video captured by the imaging device.
(18)

The information processing device according to any one of (1) to (17), wherein
the information including both the position and orientation of the sound collection device is used when the sound collection device with directional characteristics is used, and
the information including at least the position of the sound collection device is used when the sound collection device with omnidirectional characteristics is used.
(19)

An information processing method for causing an information processing device to execute:
acquiring information necessary for calculating an optimal arrangement of a sound collection device that collects a sound of a collection target, the information including at least information indicating a position or orientation of the sound collection device;
calculating an optimal arrangement of the sound collection device for collecting the sound of the collection target based on the information; and
controlling an operation in the position or orientation of the sound collection device so as to achieve the arrangement.
(20)

A program for causing a computer of an information processing device to execute information processing including:
acquiring information including at least information indicating a position or orientation of a sound collection device that collects a sound of a collection target, and acquiring information necessary for calculating an optimal arrangement of the sound collection device;
calculating an optimal arrangement of the sound collection device for collecting the sound of the collection target based on the information; and
controlling an operation in the position or orientation of the sound collection device so as to achieve the arrangement.

Embodiments of the present disclosure are not limited to the above-described embodiments and can be modified in various manners without departing from the scope and spirit of the present disclosure. Moreover, the effects described in this description are merely examples and are not limited, and other effects may also be present.

### REFERENCE SIGNS LIST

11 Capturing and sound collection system
12 Capturing camera
13 Directional microphone
14 Moving device
15 Information processing device
16 Lighting device
17 Omnidirectional microphone
18 Microphone cable
19 Recording system
21 Collection target
22 Noise source
31 User input unit
32 Operation control unit
33 Information acquisition unit
34 Positional relationship specification unit
35 Storage unit
36 Calculation processing unit
41 Recordable range estimation unit
42 Capture range estimation unit
43 Optimal arrangement calculation unit

1. An information processing device comprising:
an information acquisition unit that acquires information necessary for calculating an optimal arrangement of a sound collection device that collects a sound of a collection target, the information including at least information indicating a position or orientation of the sound collection device;
a calculation processing unit that calculates an optimal arrangement of the sound collection device for collecting the sound of the collection target based on the information acquired by the information acquisition unit; and
an operation control unit that controls an operation in the position or orientation of the sound collection device so as to achieve the arrangement calculated by the calculation processing unit.

2. The information processing device according to claim 1, wherein
the information acquisition unit acquires information indicating a position and orientation of a capturing device that captures the collection target, and information indicating the position and orientation of the collection target, and supplies the information to the calculation processing unit, and
the calculation processing unit calculates, as the optimal arrangement of the sound collection device, a direction toward the collection target at a position that can get closest to the collection target, which is inside a recordable range in which a direct sound of the collection target can be recorded when a sound axis of the sound collection device is directed toward the collection target, and outside a capture range in which the sound collection device appears in a video captured by the capturing device.

3. The information processing device according to claim 2, further comprising an input unit that inputs information used by the calculation processing unit, wherein the input unit inputs information indicating an angle of view of the capturing device, information indicating a shape and directional characteristics of the sound collection device, and information indicating a shape of a moving device that moves the sound collection device, to the calculation processing unit.

4. The information processing device according to claim 3, further comprising a positional relationship specification unit that specifies and stores a positional relationship between the sound collection device and the collection target before the capturing device starts capturing.

5. The information processing device according to claim 3, wherein
the operation control unit controls the operation in the position or orientation of the sound collection device according to specification or adjustment of the position or orientation of the sound collection device input to the input unit before the capturing device starts capturing.

6. The information processing device according to claim 3, wherein
the operation control unit controls the operation in the position or orientation of the sound collection device before the capturing device starts capturing so that the arrangement calculated by the calculation processing unit based on the information acquired before the capturing is achieved.

7. The information processing device according to claim 3, wherein
the calculation processing unit calculates the optimal arrangement of the sound collection device for collecting the sound of the collection target based also on information indicating a position of a noise source that emits noise other than the collection target.

8. The information processing device according to claim 3, wherein
the calculation processing unit calculates the optimal arrangement of the sound collection device for collecting the sound of the collection target based also on information about an irradiating device that irradiates the collection target with illumination light.

9. The information processing device according to claim 1, wherein
when one sound collection device having directional characteristics is used for a plurality of collection targets, a sound axis of the sound collection device is directed to a midpoint of the plurality of collection targets.

10. The information processing device according to claim 1, wherein
when one sound collection device having directional characteristics is used for a plurality of the collection targets, a sound axis of the sound collection device is directed toward each of the collection targets according to a time when each of the collection targets speaks.

11. The information processing device according to claim 1, wherein
the sound collection device having omnidirectional characteristics is used for a plurality of the collection targets.

12. The information processing device according to claim 1, wherein
a plurality of the sound collection devices having directional characteristics are used for each of the plurality of the collection targets.

13. The information processing device according to claim 1, wherein
an arrangement screen is displayed on a display unit, which displays areas suitable for the arrangement of the sound collection device and areas inappropriate for the arrangement of the sound collection device, and which displays at least an icon of the sound collection device.

14. The information processing device according to claim 13, wherein
when the arrangement of the sound collection device is not suitable, a message is displayed on the arrangement screen, which notifies reasons therefor.

15. The information processing device according to claim 13, wherein
the arrangement screen presents an alternative for appropriately arranging the sound collection device if the arrangement of the sound collection device is not appropriate.

16. The information processing device according to claim 1, wherein
when a moving device that moves the sound collection device is about to come into contact with another object or person, the operation control unit performs control to preferentially move the moving device so as to avoid contact with the other object or person.

17. The information processing device according to claim 1, wherein
the sound collection device is connected to a recording system that records sound via a microphone cable, and
the calculation processing unit controls the operation of the moving device equipped with the sound collection device or one or more moving devices supporting the microphone cable so as to prevent the microphone cable from appearing in the video captured by the imaging device.

18. The information processing device according to claim 1, wherein
the information including both the position and orientation of the sound collection device is used when the sound collection device with directional characteristics is used, and
the information including at least the position of the sound collection device is used when the sound collection device with omnidirectional characteristics is used.

19. An information processing method for causing an information processing device to execute:
acquiring information necessary for calculating an optimal arrangement of a sound collection device that collects a sound of a collection target, the information including at least information indicating a position or orientation of the sound collection device;
calculating an optimal arrangement of the sound collection device for collecting the sound of the collection target based on the information; and
controlling an operation in the position or orientation of the sound collection device so as to achieve the arrangement.

20. A program for causing a computer of an information processing device to execute information processing comprising:
acquiring information including at least information indicating a position or orientation of a sound collection device that collects a sound of a collection target, and acquiring information necessary for calculating an optimal arrangement of the sound collection device;
calculating an optimal arrangement of the sound collection device for collecting the sound of the collection target based on the information; and
controlling an operation in the position or orientation of the sound collection device so as to achieve the arrangement.
